(19) United States
(12) Patent Application Publication
(10) Pub. No.: US 2012/0261143 A1
(43) Pub. Date: Oct. 18, 2012

(54) DEVICES AND METHODS FOR ATTACHING A HORSESHOE TO A HOOF

(75) Inventors: John J. Craig, Paso Robles, CA (US); Monique F. Craig, Paso Robles, CA (US)

(73) Assignee: EPONASHOE, INC., Paso Robles, CA (US)

(21) Appl. No.: 13/365,839

(22) Filed: Feb. 3, 2012

Related U.S. Application Data
(60) Provisional application No. 61/441,958, filed on Feb. 11, 2011.

(51) Int. Cl. A01L 3/00

(52) U.S. Cl. 168/17

(57) ABSTRACT

Fasteners are configured to anchor a horseshoe to a hoof. The fasteners are used in conjunction with wrapping, banding and/or casting material to secure a horseshoe to a hoof. Methods of anchoring a horseshoe to a hoof employ fasteners and wrapping, banding and/or casting material.

### CROSS-REFERENCE TO RELATED APPLICATIONS

This application claims the benefit of U.S. Provisional Patent Application No. 61/441,958 filed Feb. 11, 2011, the entirety of which is incorporated herein by reference.

### FIELD OF THE INVENTION

The presently disclosed subject matter relates to methods and devices for attaching a horseshoe to a hoof. More particularly, the presently disclosed subject matter relates to fasteners to anchor almost any type of horseshoe to the hoof, and methods which employ the fasteners with wrapping or casting material that wraps the hoof and engages with the fasteners.

### BACKGROUND

An animal hoof and especially an equine hoof is composed of a relatively hard outer surface, a sole and other structures on the ground surface of the foot. The outer surface continues to grow during the animal's lifetime, similar to the human fingernail. In the wild, the growth rate of the hoof wall is approximately balanced by the wear processes as the animal moves. However, in the domestic horse, such is not the case. Due to the use humans make of the horse and the surfaces and conditions in which horses are kept, some ‘artificial’ treatment of the hoof is generally required. Most generally, a farrier will trim the hoof and apply a metal shoe to protect the foot. In recent years some non-metal shoes have also been introduced.

In typical current practice, a farrier attends to a horse about every 6 weeks. The old shoes are removed, the hooves are trimmed, and new shoes are placed on the feet.

A typical situation for a domestic horse is that the ‘toe’ portion of the hoof grows out more quickly than the ‘heel’ portion of the hoof, and hence, without periodic trimming, the angle the foot makes with the ground (as seen from a side view) would gradually change. However, a great variety of other situations concerning the shape and growth of the hoof occur, and it is the job of the farrier, sometimes with a veterinarian's advice, to determine the best course of action to maintain the health and usefulness of the horse.

A common way of attaching a horseshoe to a hoof is by means of specialized nails which require special skill to apply properly. Some shoe attachment systems instead use specialized adhesives to bond the shoe to the hoof. Another method is to wrap the hoof with wrapping tape, sometimes called casting material, and to allow this material to partially or fully cover the shoe as well, thus securing the shoe to the hoof. The problem with using casting material is that typically one of the following three methods is employed, each with drawbacks:

Current Method #1: The casting material must cover most or all of the shoe, including the ground surface contacting side (bottom) of the shoe, in order to secure it. When the ground surface contacting portion of the shoe is covered the situation arises wherein the casting material obstructs the tread-pattern and other features designed into the shoe, and also, over time, the casting material abrades and wears away from constant contact with the ground, and at the end of this process the shoe is lost.

Current Method #2: The shoe must have certain features that allow casting to secure it in place without the need for the casting to cover the ground surface of the shoe. For example, the shoe can be very thick with a large bevel around its periphery. The casting material can wrap on this bevel and hence secure the shoe without covering over the ground surface contacting portion of the shoe. The drawback with this method is that it cannot be used with most horseshoes on the market today, all of which have been designed in a certain way, for a certain reason.

Current Method #3: Casting the bare hoof, then bonding the shoe onto the casting material that has been wrapped on the ground surface contacting side of the hoof. In this method, the casting material provides a surface that is easier to bond to than the equine hoof itself, and there may be the advantage of the adhesive bond lasting longer. However, this method requires expensive adhesive, and also one ends up with a large, thick layer of casting material and adhesive between the bottom of the hoof and the top of the shoe, which is generally undesirable.

Therefore, it would be desirable to provide devices and methods which permit use of the popular wrapping tape or casting materials now available and others coming available in the future without the aforementioned drawbacks.

### SUMMARY OF THE INVENTION

The presently disclosed subject matter pertains generally to fasteners which are operable on one end to secure the horseshoe (by inserting into existing nail holes in the shoe), and on the other end to engage casting material.

In accordance with one embodiment a fastener is disclosed having a point configured to fit in and engage an opening formed in the ground-facing side of a horseshoe and a shank configured to wrap around the outside of the horseshoe toward the hoof. The fastener may comprise essentially a hook which may fit into a horseshoe by slipping the point of the hook into an existing nail hole of a horseshoe. A channel between the point and the shank of the fastener may engage a portion of the horseshoe. The shank of the fastener may fit snugly against the outside of the shoe and partially up the outer wall of the hoof. On the shank portion of the fastener, on the side opposite the hoof facing side, there may be disposed one or more bumps, barbs or other protrusions so that wrapping, casting or banding material, when wrapped around the hoof, engages with the bumps, barbs, or protrusions. The result is that by using two or more of these hook-type fasteners a horseshoe can be secured to the horse's hoof using wrapping tape, bands, or casting material. These hook-type fasteners can be sized and shaped to work with almost any horseshoe currently on the market, as well as with almost any wrapping, banding, or casting material currently on the market.

In one embodiment, the fastener is configured such that the channel of the fastener fits between raised tread on a shoe such as a synthetic shoe available commercially from Epona Shoe of Paso Robles, Calif. in such a way that the fastener does not come in contact with the ground at all, and the horse walks entirely on the ground-contacting surface of the shoe as the shoe was designed for. Shoe features such as grip and non-scuff use are maintained even with the hooks in use.

### BRIEF DESCRIPTION OF THE FIGURES

FIG. 1 perspective view of a casting hook in accordance with one embodiment of the disclosed subject matter;

FIG. 1A is a perspective view of a detail of the casting hook according to FIG. 1;

FIG. 2 is a side view of the casting hook according to FIG. 1;

FIG. 3 is a bottom plan view of a horseshoe having a plurality of openings to accommodate a casting hook in accordance with one embodiment of the disclosed subject matter;

FIG. 4 is a cross-section of the shoe of FIG. 3 through line A-A′ in accordance with one embodiment of the disclosed subject matter;

FIG. 5 is a perspective view of a horse's hoof with a glued-on shoe and a plurality of casting hooks placed in the shoe, prior to applying the casting material in accordance with one embodiment of the disclosed subject matter;

FIG. 6 is a side view of a hoof with casting material wrapped around the hoof, and casting hooks shown in phantom in accordance with one embodiment of the disclosed subject matter; and

FIG. 7 is a bottom view of a hoof of a horse including casting hooks in existing nail holes, fitted between tread on the shoe, and casting material wrapped on the outside of the hoof and casting hooks.

### DETAILED DESCRIPTION OF THE INVENTION

In the following description, for purposes of explanation, specific numbers, materials and configurations are set forth in order to provide a thorough understanding of the invention. It will be apparent, however, to one having ordinary skill in the art that the invention may be practiced without these specific details. In some instances, well-known features may be omitted or simplified so as not to obscure the present invention. Furthermore, reference in the specification to “one embodiment” or “an embodiment” means that a particular feature, structure or characteristic described in connection with the embodiment is included in at least one embodiment of the invention. The appearances of the phrase “in one embodiment” in various places in the specification are not necessarily all referring to the same embodiment.

In general the subject matter disclosed herein includes fastener devices that may be referred to casting hooks and the method of use thereof. These fastener devices and the methods of their use facilitate attachment of a horseshoe a horse hoof by use of any kind of wrapping, banding, or casting material commonly known and used in the art. This wrapping material may be soft, rigid, flexible or any combination of these properties. The fastener devices and methods of use can be used with almost any horseshoe currently in use today.

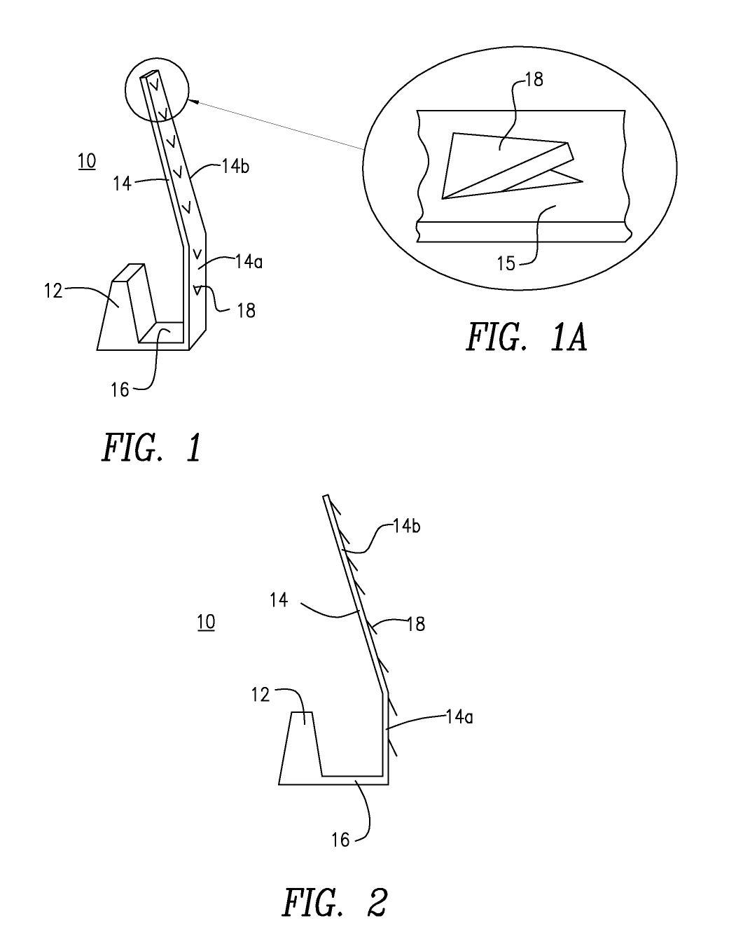

Now referring to FIGS. 1-2, an exemplary casting hook fastener 10 is configured to connect a horseshoe to an equine hoof having a point 12, shank 14, channel 16 and protrusions 18. While FIGS. 1-2 shows a generally square bend confining channel 16, so that the fastener 10 is generally L-shaped, one skilled in the art will recognize the bend of the hook fastener 10 may be curvilinear on the channel 16 side and/or the opposite side of the channel 16, so that the fastener may have a bend forming a “J” shape.

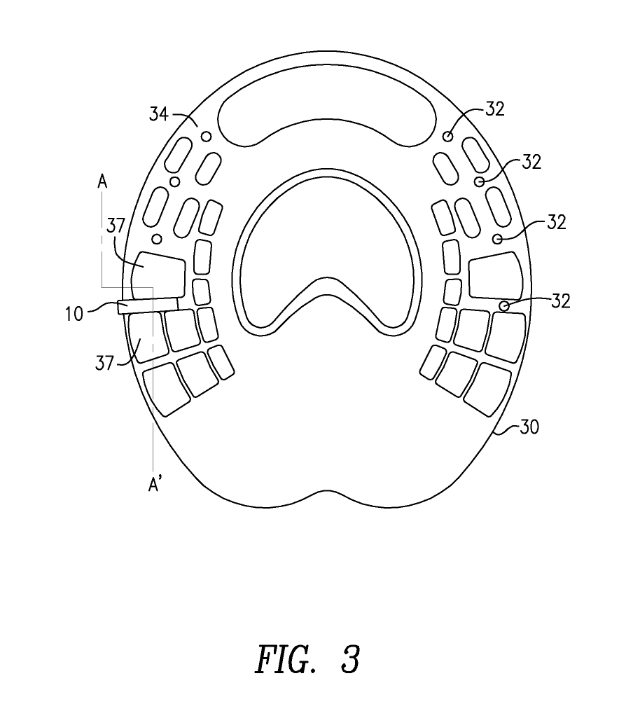

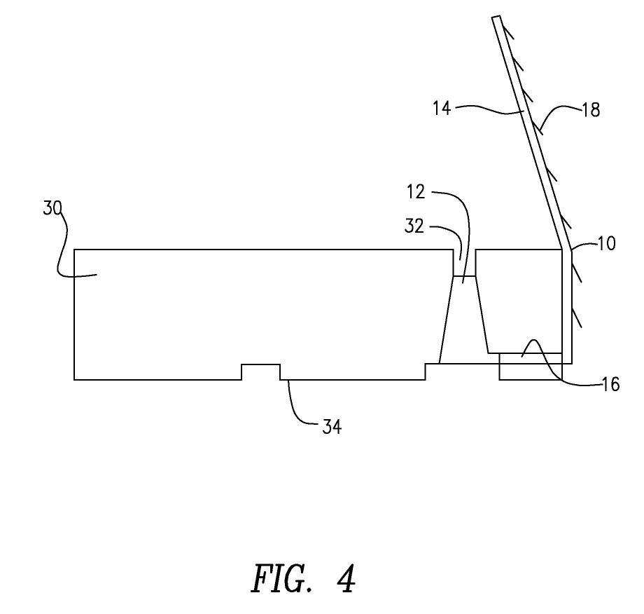

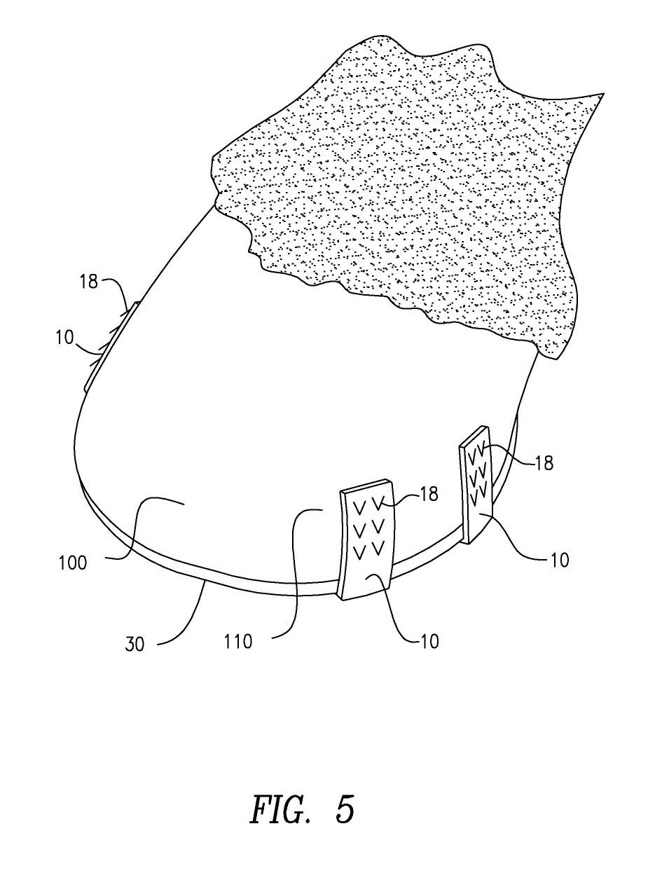

With further reference to FIG. 3, a horseshoe 30 may include one or more nail holes 32. With further reference to FIG. 4, point 12 is configured to fit into a nail hole 32 of a horseshoe 30. If need be, new holes can be drilled in a horseshoe 30 to accommodate the fastener 10. In one embodiment, point 12 is configured to fit in a pre-existing nail-hole found in most commercially available horseshoes, such as but not limited to any horse shoe available from Epona Shoe of Paso Robles, Calif. With further reference to FIG. 5, shank 14 is configured and constructed to lie close and substantially parallel to the outer surface 110 of a hoof 100. Channel 16 is formed between point 12 and shank 14 and is configured to engage a ground-facing side 34 of a horseshoe 30. The fastener can be tapped into a nail hole 32 using a hammer, or by applying force adequate for point 12 to engage the nail hole 32. The fastener 10 need not be driven into the hoof of the horse to be shoed.

The exterior surface 15 of shank 14 includes protrusions 18 configured to engage with wrapping, banding or casting material to hold the material securely to the hoof. Protrusions 18 may be pointed, rounded or the like, it being understood that the protrusion 18 should be configured to adequately engage a given wrapping, banding or casting material. The protrusions 18 may be formed on shank 14 in any suitable manner, such as by such as by attachment, adhering or the like. In one embodiment, protrusions 18 are formed by punching shank 14 to produce barbs. Although the protrusions 18 are shown in the FIGs as pointing in a direction opposite that of the point 12, the protrusions may be pointed in any direction relative to the point 12 and/or the shank 14.

Wrapping, banding or casting materials are well known to those having ordinary skill in the art and may include without limitation fiberglass, fiberglass composite, fabric with or without an impregnating resin, moldable plastic and the like.

The fastener 10 may be made of any suitable material such as metal, plastic, polyimide, polymer or the like. In a preferred embodiment, the casting hook fastener 10 is made of metal which allows the shank 14 to be bent slightly and shaped as needed to fit near to the outer surface 110 of a hoof.

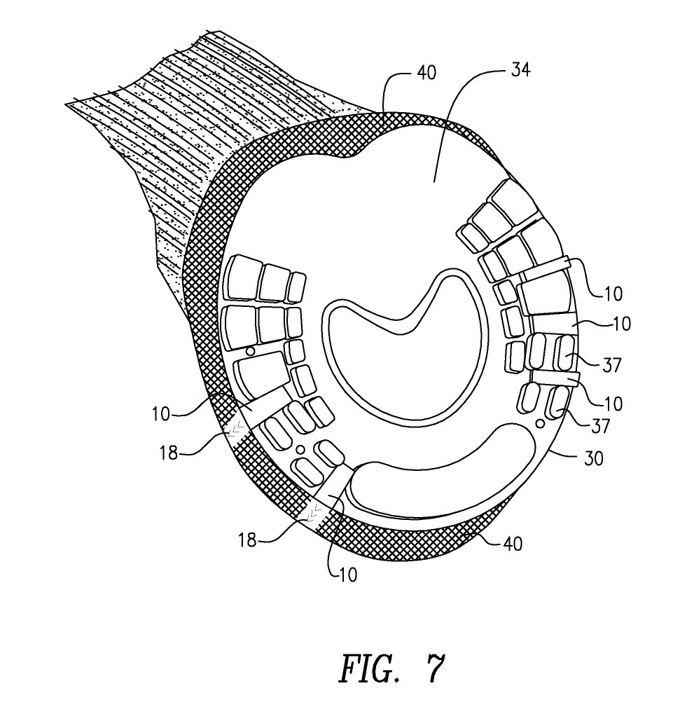

One skilled in the art will recognize casting hook fastener 10 may be any suitable size to accommodate the large variation in sizes of horseshoes. For example and not by way of limitation, in one embodiment, point 12 is about 0.30 to about 0.60 inches in length and has a base having a width of about 0.20 to about 0.40 inches. Channel 18 may be about 0.30 to about 0.50 inches in length. Shank 14 may be about 1.15 to about 2.10 inches in length and may include a substantially straight section 14a which corresponds roughly to a thickness of a horseshoe 30 with which the fastener is to be, or is being, used, and a substantially straight section 14b which is angled relative to section 14a to conform to an angle of a horse hoof relative to the ground. Section 14a may be about 0.40 to about 0.60 inches in length and section 14b may be about 0.75 to about 1.50 in length. In one embodiment, point 12 is about 0.40 inches in length and has a base having a width of about 0.25 inches. Channel 18 may be about 0.35 inches in length. Shank 14 may be about 1.50 inches in length and may include a substantially straight section 14a which may be about 1.0 inch in length and section 14b which may be about 0.5 inches in length. With reference to FIGS. 3 and 7, in one embodiment the fastener 10 is configured fit between the treads 37 on the ground-contacting side 34 of the horseshoe so that the fasteners 10 do not come in contact with the ground when the horse stands on even ground.

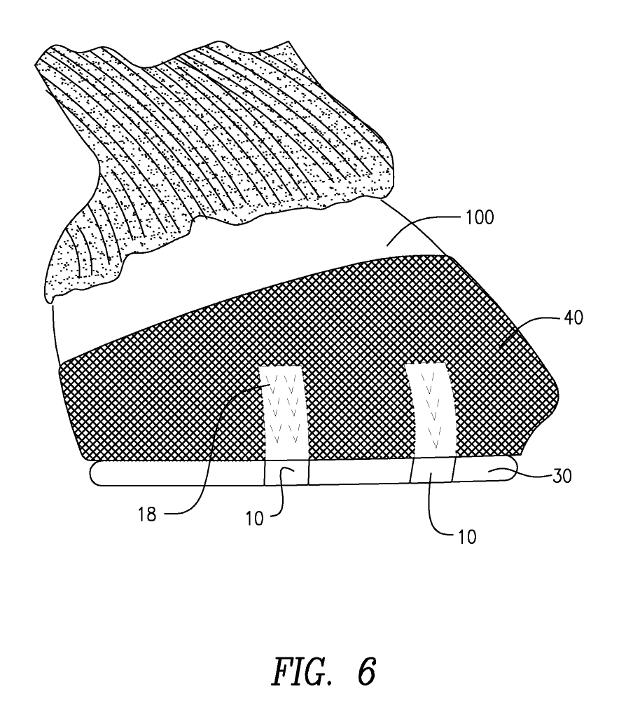

With further reference to FIG. 5, after the fasteners 10 are placed in the horseshoe 30, the horseshoe 30 may be glued to the hoof 100 with an adhesive prior to addition of wrapping, banding or casting material. This step is not necessarily required. In one embodiment, the horseshoe may be secured to the hoof 100 solely by means of fasteners 10 and casting material. Now referring to FIGS. 6 and 7, casting material 40 such as fiberglass wrap is wrapped around hoof 100 and fasteners 10. Protrusions 18 of fasteners 10 engage casting material 40.

Methods of attaching a horseshoe to a horse hoof include inserting fasteners as disclosed herein into existing openings formed (or if no such openings exist, forming openings) in a horseshoe, contacting the horseshoe to the hoof, and applying wrapping, banding or casting material around the horseshoe such that the material contacts protrusions extending from a surface of the fasteners. The horseshoe may be glued to the hoof prior to the wrapping, banding or casting operation, or prior to insertion of the fasteners. Optionally, the wrapping, banding, or casting material may be further secured to the hoof wall by means of adhesive between it and the hoof wall.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claim(s).

What is claimed is:

1. A hook fastener for an equine horseshoe comprising a shank having an interior and exterior surface, a point and a channel formed between the shank and the point, the exterior surface of the shank having at least one protrusion extending therefrom.

2. The hook fastener according to claim 1 wherein the shank, point and channel form an L-shaped hook.

3. The hook fastener according to claim 1 wherein the at least one protrusion comprises a barb.

4. The hook fastener according to claim 1 wherein the point is configured to fit into a nail hole of a horseshoe.

5. The hook fastener according to claim 1 wherein the shank is configured to lie close and substantially parallel to an outer surface of a hoof when the point is engaged in a nail hole of a horseshoe.

6. The hook fastener according to claim 1 wherein the channel is configured to engage a ground-facing side of a horseshoe.

7. The hook fastener according to claim 1 wherein the protrusions are configured to engage with wrapping, banding or casting material to hold the material securely to the hoof of an equine animal.

8. The hook fastener according to claim 1 wherein the shank comprises a first substantially straight section which corresponds to a thickness of a horseshoe with which the fastener is to be, or is being, used, and a second substantially straight section which is angled relative to the first substantially straight section to conform to an exterior surface of an equine hoof.

9. The hook fastener according to claim 1 configured fit between treads on ground-contacting side of a horseshoe.

10. A method of attaching a horseshoe to an equine hoof comprising providing a hook fastener according to claim 1 into an opening formed in a horseshoe, contacting the horseshoe to the equine hoof, and applying wrapping, banding or casting material around the horseshoe such that the material contacts the protrusions extending from a surface of the fasteners.

11. The method according to claim 10 comprising the step of applying adhesive to the equine hoof or horseshoe prior to contacting the horseshoe to the hoof.

12. The method according to claim 10 comprising securing the wrapping, banding or casting material to a wall of the hoof with adhesive.
